(19) United States
(12) Patent Application Publication
(10) Pub. No.: US 2026/0046190 A1
(43) Pub. Date: Feb. 12, 2026

(54) DECENTRALIZED HIERARCHICAL CONTROL PLANE FOR VIRTUALIZATION MANAGEMENT IN EDGE DEVICES AND HYBRID CLOUD ENVIRONMENTS

(71) Applicant: Red Hat, Inc., Raleigh, NC (US)

(72) Inventors: Christian Pinto, Dublin (IE); Srikumar Venugopal, Dublin (IE); Leigh Griffin, Waterford (IE); Stephen Coady, Dublin (IE)

(21) Appl. No.: 18/796,701

(22) Filed: Aug. 7, 2024

(51) Int. Cl. H04L 41/044; H04L 41/00; H04L 41/042; H04L 41/16; H04L 47/83

(52) U.S. Cl. CPC H04L 41/044; H04L 41/042; H04L 41/16; H04L 41/30; H04L 47/83

(57) ABSTRACT

Aspects of the present disclosure relate to a decentralized hierarchical control plane for management in edge devices and hybrid cloud environments. More specifically, a method of the present disclosure includes obtaining, at a device, an indication that the device is to act as a control node in a decentralized hierarchical control plane, where the decentralized hierarchical control plane includes a plurality of control nodes in a decentralized hierarchy. The method includes managing, by a processing device at the device acting as the control node and via the decentralized hierarchical control plane, resources associated with a plurality of devices in the decentralized hierarchy.

### TECHNICAL FIELD

Aspects of the present disclosure relate to cloud and edge computing, and more particularly, to a decentralized hierarchical control plane for management in edge devices and hybrid cloud environments.

### BACKGROUND

Cloud computing refers to a paradigm by which computing services/resources, such as servers, storage, databases, networking, software, analytics, and intelligence, are delivered over the Internet to user devices. Cloud computing may be characterized by on-demand self-service (i.e., the cloud can automatically provision resources without human interaction with a service provider), broad network access (i.e., the cloud can be accessed by different devices with varying capabilities, such as mobile phones, tablets, smartphones, laptops, and workstations), resource pooling (i.e., the cloud can serve multiple different clients), rapid elasticity (i.e., the cloud can dynamically scale computing resources both upwards and downwards based on needs of clients), and measured service (i.e., the cloud monitors computing resources used by clients). Some clouds may be distributed over multiple centers across disperse geographic locations. A cloud may be a public cloud (i.e., a cloud that utilizes a shared infrastructure) or a private cloud (i.e., a cloud that utilizes an infrastructure of an organization). Compared to other types of computing paradigms, cloud computing may provide various advantages to clients, such as scalability, performance increases, device independence, decreased maintenance, and increased availability.

Edge computing refers to a distributed computing model that brings computation and data storage to a location of a source of data. In an example, edge computing seeks to distribute computation to devices (i.e., edge devices) located physically closer to a user device so as to reduce latency compared to a situation in which a centralized data center (e.g., a centralized data center belonging to a cloud) executes an application for the user device. A hybrid cloud refers to a mixed computing environment in which applications run using a combination of computing, storage, and services in different environments including public clouds and private clouds, on-premises data centers, and edge devices.

### BRIEF DESCRIPTION OF THE DRAWINGS

The described aspects and the advantages thereof may best be understood by reference to the following description taken in conjunction with the accompanying drawings. These drawings in no way limit any changes in form and detail that may be made to the described aspects by one skilled in the art without departing from the spirit and scope of the described aspects.

FIG. 1 is a block diagram that illustrates an example of a decentralized hierarchical control plane for management in edge devices and hybrid cloud environments in accordance with some aspects of the present disclosure.

FIG. 2 is a block diagram that illustrates examples of decentralized hierarchical control planes for management in edge devices and hybrid cloud environments in accordance with some aspects of the present disclosure.

FIG. 3 is a block diagram that illustrates an example system in accordance with some aspects of the present disclosure

FIG. 4 is a flow diagram of a method for a decentralized hierarchical control plane for management in edge devices and hybrid cloud environments in accordance with some aspects of the present disclosure.

FIG. 5 is a block diagram of an example of a computer system that may perform one or more of the operations described herein in accordance with some aspects of the present disclosure.

### DETAILED DESCRIPTION

A control plane may refer to a part of a network that is responsible for configuring and managing resources in the network and/or behaviors in the network. In an example, a control plane may include a network topography, routers, switches, etc. A control plane may enforce various policies pertaining to the network such as access control, quality of service, security rules, etc. A control plane may also allocate resources in/across a network. For instance, a control plane may balance resources (e.g., bandwidth resources, storage resources) across the network so that a particular portion of the network is not overloaded.

A hybrid cloud refers to a mixed computing environment in which applications run using a combination of computing, storage, and services in different environments including public clouds and private clouds, on-premises data centers, and edge devices. A control plane for a hybrid cloud may be a centralized control plane in which policies are enforced and/or resources are allocated by a central node, that is, the central node may manage all aspects of a managed device throughout a life cycle of the device, such as policies and/or resource allocation. A centralized control plane for a hybrid cloud may be associated with various deficiencies. For instance, a centralized control plane may be fault intolerant due to the centralized nature of the centralized control plane. Furthermore, a centralized control plane may be unable to manage devices of varying characteristics, such as edge devices. For example, a centralized control plane may be unable to manage solar powered edge devices at nighttime when the solar powered edge devices are nonoperational or operating in a reduced power mode.

The present disclosure addresses the above-noted and other deficiencies by using a processing device for a decentralized hierarchical control plane. In an example, the processing device obtains, at a device, an indication that the device is to act as a control node in a decentralized hierarchical control plane, where the decentralized hierarchical control plane includes a plurality of control nodes in a decentralized hierarchy. The processing device manages, at the device acting as the control node and via the decentralized hierarchical control plane, resources associated with a plurality of devices in the decentralized hierarchy. Vis-à-vis obtaining the indication that the device is to act as the control node and managing, via the decentralized hierarchical control plane, the resources associated with the plurality of devices in the decentralized hierarchy, the processing device may facilitate a greater level of resilience to changing network conditions compared to a processing device that manages resources via a centralized control plane. For instance, via the decentralized hierarchical control plane, the processing device may more efficiently allocate resources and/or apply policies compared to allocating resources and/or applying policies via a centralized control plane.

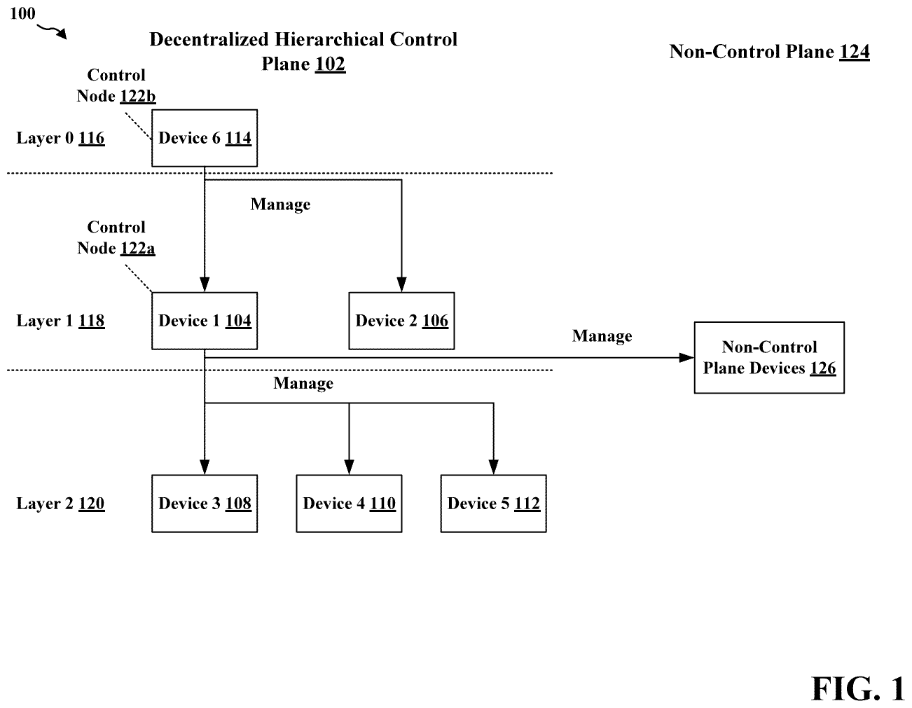

FIG. 1 is a block diagram 100 that illustrates an example of a decentralized hierarchical control plane 102 for management in edge devices and hybrid cloud environments in accordance with some aspects of the present disclosure. In the example depicted in the block diagram 100, the decentralized hierarchical control plane 102 includes a first device 104, a second device 106, a third device 108, a fourth device 110, a fifth device 112, and a sixth device 114. The first device 104, the second device 106, the third device 108, the fourth device 110, the fifth device 112, and the sixth device 114 may be collectively referred to as a plurality of devices 104-114.

In some aspects, each of the plurality of devices 104-114 may be a same type of device (e.g., each of the plurality of devices 104-114 may be edge devices). In other aspects, the plurality of devices 104-114 may include different device types. For example, the first device 104 may be a first device type (e.g., an edge device) and the second device 106 may be a second device type (e.g., a device associated with a cloud infrastructure), where the first device type and the second device type may be different. In another example, the first device 104 may be a first device type and the third device 108 may be a second device type, where the first device type is different from the second device type. In some aspects, the plurality of devices 104-114 may include edge device(s) located near user device(s), device(s) associated with a cloud infrastructure, Internet-of-Things (IoT) device(s), and/or device(s) associated with a hybrid cloud infrastructure.

In some aspects, one or more of the plurality of devices 104-114 may perform virtualization. For example, one or more of the plurality of devices 104-114 may execute a virtual machine or a container. In some aspects, one or more of the plurality of devices 104-114 may perform bare metal virtualization in which no operating system exists between hardware and virtualization software.

The plurality of devices 104-114 may communicate with one another (and/or with other devices) via a network. The network may be a public network (e.g., the internet), a private network (e.g., a local area network (LAN) or a wide area network (WAN)), or a combination thereof. In one example, the network may include a wired or a wireless infrastructure, which may be provided by one or more wireless communications systems, such as a WiFi™ hotspot connected with the network and/or a wireless carrier system that can be implemented using various data processing equipment, communication towers (e.g., cell towers), etc. The network may carry communications (e.g., data, message, packets, frames, etc.) between the plurality of devices 104-114 (and/or between the other devices). The plurality of devices 104-114 may include hardware such as processing devices (e.g., processors, central processing units (CPUs)), memory (e.g., random access memory (RAM), storage devices (e.g., hard-disk drives (HDDs)), and solid-state drives (SSDs), etc.), and other hardware devices (e.g., sound cards, video cards, etc.). The plurality of devices 104-114 may include sensors (e.g., temperature sensors, moisture sensors, etc.). A storage device may include a persistent storage that is capable of storing data. A persistent storage may be a local storage unit or a remote storage unit. Persistent storage may be a magnetic storage unit, an optical storage unit, a solid state storage unit, an electronic storage units (main memory), or a similar storage unit. Persistent storage may also be a monolithic/single device or a distributed set of devices.

In some aspects, the plurality of devices 104-114 may include any suitable type of computing device or machine that has a programmable processor including, for example, server computers, desktop computers, laptop computers, tablet computers, smartphones, set-top boxes, etc. The plurality of devices 104-114 may each execute or include an operating system (OS). The OS may manage the execution of other components (e.g., software, applications, etc.) and/or may manage access to the hardware (e.g., processors, memory, storage devices etc.) of a device in the plurality of devices 104-114.

The decentralized hierarchical control plane 102 may include a zeroth layer 116, a first layer 118, and a second layer 120 (referred to hereafter as a plurality of layers 116-120). The zeroth layer 116 may include/be associated with the sixth device 114. The first layer 118 may include/be associated with the first device 104 and the second device 106. The second layer 120 may include/be associated with the third device 108, the fourth device 110, and the fifth device 112. Although the example in the block diagram 100 depicts the zeroth layer 116 as including one device, the first layer 118 as including two devices, and the second layer 120 as including three devices, it is to be understood that each layer may include any number of devices. For example, the first layer 118 may include more devices than devices of the second layer 120 or the first layer 118 may include the same number of devices than devices of the second layer 120. In another example, the zeroth layer 116 may include more devices than devices of the first layer 118 or the zeroth layer 116 may include the same number of devices than devices of the first layer 118. Furthermore, although the example in the block diagram 100 depicts three layers, it is to be understood that the decentralized hierarchical control plane 102 may include at least two layers (e.g., two layers, four layers, ten layers, etc.). In some aspects, a number of layers in the decentralized hierarchical control plane 102 may be dynamically increased or dynamically decreased by device(s) in the decentralized hierarchical control plane 102 based on condition(s) (e.g., resource availability, system demand, etc.).

In a layer in the decentralized hierarchical control plane 102, a device may act as a control node. A device may be configured to act as the control node or the device may begin to operate as the control node upon obtaining an indication (described in greater detail below). In general, a device acting as a control node in a layer manages resource(s) of device(s) in a layer located beneath the device. For example, in the decentralized hierarchical control plane 102 depicted in FIG. 1, the first device 104 acts as a control node 122a for the first layer 118 and the sixth device 114 acts as a control node 122b for the zeroth layer 116. As such, the first device 104 (acting as the control node 122a) manages resources of the third device 108, the fourth device 110, and the fifth device 112 and the sixth device 114 (acting as the control node 122b) manages resources of the first device 104 and the second device 106. Managing resources of a device (e.g., resources of the third device 108) may include managing compute resources, network resources, virtualization associated resources, cloud resources, power resources, and/or workloads.

In some aspects, managing resources may be based on data received from a device from a higher layer in the decentralized hierarchical control plane 102, data received from a lower layer in the decentralized hierarchical control plane 102, data from a sensor of a device, and/or computations performed by the device. In one example, the first device 104 may manage resources of the third device 108, the fourth device 110, and/or the fifth device 112 based on data received from the third device 108, the fourth device 110, and/or the fifth device 112. In another example, the first device 104 may manage resources of the third device 108, the fourth device 110, and/or the fifth device 112 based on data received from the sixth device 114. In a further example, the first device 104 may manage resources of the third device 108, the fourth device 110, and/or the fifth device 112 based on data from a sensor of the first device 104. In yet another example, the first device 104 may manage resources of the third device 108, the fourth device 110, and/or the fifth device 112 based on computations performed by the first device 104. The computations may be based on the data received from a lower layer described above, the data received from a higher layer described above, and/or the sensor data described above.

In some aspects, managing resources of a device may include transmitting indication(s) of adjustment(s) to the resources. For example, the first device 104 may transmit indication(s) of resource adjustment(s) to the third device 108, the fourth device 110, and/or the fifth device 112, and the third device 108, the fourth device 110, and/or the fifth device 112 may implement the adjustment(s) based on the indication(s). In a specific example, the indication(s) may indicate that the third device 108, the fourth device 110, and/or the fifth device 112 are to operate in a low power mode, and based on receiving the indication(s), the third device 108, the fourth device 110, and/or the fifth device 112 may operate in the low power mode. In another specific example, the indication(s) may indicate that the third device 108, the fourth device 110, and/or the fifth device 112 are to increase an amount of memory used for virtualization purposes (e.g., executing a virtual machine, executing a container, etc.), and based on receiving the indication(s), the third device 108, the fourth device 110, and/or the fifth device 112 may increase an amount of memory used for virtualization purposes.

In some aspects, resources of a device may be managed by receiving indication(s) of adjustment(s) to the resources (i.e., a resource adjustment). For example, the sixth device 114 may transmit an indication of a resource adjustment to the first device 104. The first device 104 may apply the resource adjustment based on the indication.

In some aspects, managing resources of a device may include redistributing a workload from one device to another device. In an example, a workload may be scheduled for execution on the third device 108. The first device 104 may determine that the workload is to be rescheduled based on various factors (e.g., resource availability at the third device 108 or another device, network conditions, system demands, etc.). The first device 104 may redistribute the workload from the third device 108 to another device (e.g., the fourth device 110 and/or the fifth device 112) based on the determination.

In some aspects, managing resources may include increasing or decreasing the resources. In an example, the first device 104 may increase or decrease an amount of bandwidth available to the third device 108, the fourth device 110, and/or the fifth device 112 based on network congestion (or based on other factor(s)).

In some aspects, a device in the decentralized hierarchical control plane 102 may monitor data associated with the decentralized hierarchical control plane 102 (and/or another decentralized hierarchy associated with the decentralized hierarchical control plane 102). For example, the first device 104 may monitor the data. The first device 104 may manage the resources of the third device 108, the fourth device 110, and/or the fifth device 112 based on the monitoring. In some aspects, the aforementioned data may include a relatively large amount of data. Processing and/or monitoring such data may be computationally complex. In such aspects, a device acting as a control node (e.g., the first device 104) may execute a data filtering technique and/or a data distribution technique on the data and the device may manage the resources based on the executed data filtering technique and/or the executed data distribution technique. A data filtering technique may refer to a process of removing and/or modifying unwanted or irrelevant values from data, such as errors, outliers, noise, or duplicate values. In an example, a data filtering technique may include clustering and/or data imputation. A data distribution technique may refer to the dissemination of data across various data storage locations, systems, or computing nodes.

In some aspects, a device (e.g., the first device 104) in the decentralized hierarchical control plane 102 may generate, via a machine learning model, a prediction pertaining to resources associated with devices. For example, the first device 104 may monitor data associated with the decentralized hierarchical control plane 102 (and/or another decentralized hierarchy associated with the decentralized hierarchical control plane 102). The first device 104 may provide the data as input to the machine learning model. The machine learning model may output a prediction based on the data and learned parameters (e.g., weights) of the machine learning model. The first device 104 may manage device(s) in the second layer 120 based on the prediction. In an example, the machine learning model may be trained to output a prediction pertaining to resource utilization of devices. In the example, the prediction may indicate that the device(s) in the second layer 120 are predicted to utilize a relatively high amount of network bandwidth in a point in time in the future. The first device 104 may increase an amount of bandwidth allocated to the device(s) in the second layer 120 at the point in time in the future so as to not impede network functionality.

In some aspects, a device acting as a control node in the decentralized hierarchical control plane 102 may perform functions in addition to managing devices in a lower layer of the decentralized hierarchical control plane 102. For instance, the first device 104, when acting as the control node 122a, may manage device(s) in the second layer 120 while also hosting (i.e., executing), a workload scheduled by the sixth device 114 acting as the control node 122b.

In some aspects, each device in a layer in the plurality of layers 116-120 is the same device type. For example, the first device 104 and the second device 106 may both be edge devices. In some aspects, a layer in the plurality of layers 116-120 may include different device types. For example, the first device 104 may be an IoT device and the second device 106 may be a device associated with a cloud infrastructure.

In some aspects, the plurality of layers 116-120 may be based on a geographic region, a device type, a device capability, and/or a device use. In an example with respect to geographic region, the zeroth layer 116 may be associated with a first geographic region (e.g., the sixth device 114 may be located in the first geographic region), the first layer 118 may be associated with a second geographic region (e.g., the first device 104 and the second device 106 may be located in the second geographic region), and the second layer 120 may be associated with a third geographic region (e.g., the third device 108, the fourth device 110, and the fifth device 112 may be located in the third geographic region). In some aspects, the first geographic region may be larger than the second geographic region and the second geographic region may be larger than the third geographic region. Additionally or alternatively, in some aspects, the first geographic region encompasses the second geographic region and the second geographic region encompasses the third geographic region. In another example with respect to device type, the zeroth layer 116 may include devices associated with a cloud infrastructure, the first layer 118 may include edge computing devices, and the second layer 120 may include IoT devices.

In some aspects, a device in a layer in the decentralized hierarchical control plane 102 may transition to a different layer (e.g., a higher layer or a lower layer than a current layer) in the decentralized hierarchical control plane 102 based on data received from another layer, sensor data, data received from other devices in the layer, and/or computations. In an example, the first device 104 may obtain an indication that the first device 104 is to transition to the second layer 120 (or another layer). In an example, the indication may be received from the sixth device 114. In another example, the indication may be obtained based on a computation performed by the first device 104. The first device 104 may transition from the first layer 118 to the second layer 120 based on the indication. In some aspects, the first device 104 may continue to act as a control node after transitioning. For instance, subsequent to transitioning to a new layer (e.g., the zeroth layer 116, the second layer 120, etc.), the first device 104 may obtain, from a higher layer in the decentralized hierarchical control plane 102, a configuration that configures the first device 104 to act as a control node in the new layer. In some other aspects, the first device 104 ceases to act as a control node after transitioning.

In some aspects, managing resources of device(s) in the decentralized hierarchical control plane 102 may be based on a consensus. In an example, the first device 104 may transmit, to device(s), a vote pertaining to the resources. In an example, the vote may be indicative of one of a plurality of actions to take to manage the resources. In a specific example, the vote may indicate that devices in the second layer 120 are to transition to a low power mode or that the devices in the second layer 120 are to maintain regular operation. The vote may be based on various factors, such as network conditions, device capabilities, and/or system demands. Additionally or alternatively, the votes may be based on data received from a device in the zeroth layer 116 and/or the second layer 120, sensor data from a sensor of the first device 104, and/or a computation performed by the first device 104. In an example, the device(s) may include other device(s) from the first layer 118 (e.g., the second device 106) and/or device(s) from layers other than the first layer 118 (e.g., device(s) from the zeroth layer 116). The first device 104 may also receive, from the device(s), votes pertaining to the resources, where each vote in the votes is indicative of one of the plurality of actions to take to manage the resources. The first device 104 may manage the resources based on the vote and the votes (collectively, “the plurality of votes”). For example, if a majority of the plurality of votes indicates that the devices in the second layer 120 should transition to a low power mode, the first device 104 may transmit an indication to the devices in the second layer 120 to transition to a low power mode, whereas if a majority of the plurality of votes indicates that the devices in the second layer 120 should maintain regular operation, the first device 104 may transmit an indication to the devices in the second layer 120 to maintain regular operation. Alternatively, the first device 104 may refrain from transmitting an indication to the devices in the second layer 120, and hence the devices in the second layer 120 may continue to maintain regular operation.

In some aspects, a layer may include devices that are candidate control nodes. A candidate control node may refer to a device that is capable of acting as a control node in the decentralized hierarchical control plane 102, but that is not currently acting as a control node. In an example, the second device 106 may be a candidate control node. In such aspects, an identity of a control node in the decentralized hierarchical control plane 102 may change.

In an example, the first device 104 may receive an indication from the sixth device 114 (acting as the control node 122b) indicating that the first device 104 is to cease acting as the control node 122a. For instance, the sixth device 114 may transmit the aforementioned indication to the first device 104. Similarly, the second device 106 may receive an indication from the sixth device 114 indicating that the second device 106 is to act as the control node 122a. For instance, the sixth device 114 may transmit the aforementioned indication to the second device 106. Based on the indications, the first device 104 may cease acting as the control node 122a and the second device 106 may begin acting as the control node 122a, that is, the first device 104 may cease managing resources associated with the devices in the second layer 120 and the second device 106 may begin managing the resources associated with the devices in the second layer 120. In some aspects, the sixth device 114 may transmit one indication to the first device 104 or the second device 106 indicating that the first device 104 is to cease acting as the control node 122a or that the second device 106 is to begin acting as the control node 122a. The first device 104 and the second device 106 may communicate based on the indication in order for the first device 104 to cease acting as the control node 122a and for the second device 106 to begin acting as the control node 122a.

In another example, a device may autonomously determine to change the identity of the control node within a layer in the decentralized hierarchical control plane 102. In an example, the first device 104 may determine that the second device 106 is to act as the control node 122a and that the first device 104 is to cease acting as the control node 122a. The determination may be based on data from an upper layer in the decentralized hierarchical control plane 102, data from a lower layer in the decentralized hierarchical control plane 102, sensor data gathered by the first device 104, computations performed by the first device 104, and/or data from the first layer 118 of the decentralized hierarchical control plane 102. The first device 104 and the second device 106 may communicate based on the indication in order for the first device 104 to cease acting as the control node 122a and for the second device 106 to begin acting as the control node 122a.

In some aspects, changing the identity of the control node within a layer may be based on functionality of the control node becoming impaired, functionality of the control node being predicted to become impaired, the control node becoming nonoperational, or the control node being predicted to become nonoperational. In an example, the sixth device 114 may determine that functionality of the first device 104 acting as the control node 122a in the first layer 118 is or is predicted to become impaired and/or that the first device 104 is or is predicted to become nonoperational. The sixth device 114 may change the identity of the control node 122a from the first device 104 to the second device 106 as described above. In another example, the first device 104 may determine that functionality of the first device 104 is or is predicted to become impaired and/or that the first device 104 is or is predicted to become nonoperational. The first device 104 may communicate with the second device 106 in order to change the identity of the control node as described above.

In some aspects, changing the identity of the control node within a layer may be based on resource availability, network conditions, and/or system demands. In an example, the third device 108, the fourth device 110, and the fifth device 112 may be IoT devices attached to vehicles travelling in an environment. The first device 104 acting as the control node 122a (or the sixth device 114 acting as the control node 122b) may determine that the third device 108, the fourth device 110, and the fifth device 112 are moving outside of a particular range of the first device 104 and into a range of the second device 106. The first device 104 and/or the sixth device 114 may change the identity of the control node 122a from the first device 104 to the second device 106 in a manner similar to that described above in order to reduce latency for communications between the first layer 118 and the second layer 120.

Although the description of FIG. 1 above describes the decentralized hierarchical control plane 102 in a top-to-bottom manner, that is, devices in lower layers are managed by devices in upper layers, other possibilities are contemplated. In some aspects, the devices in the upper layers are managed by devices in the lower levels (i.e., a bottom-to-top manner).

In some aspects, the decentralized hierarchical control plane 102 may be part of a decentralized hierarchy. The decentralized hierarchy may include the decentralized hierarchical control plane 102 and a non-control plane 124. The non-control plane 124 may include non-control plane device 126. The non-control plane devices 126 may be identical to or similar to any of the devices described herein; however, the non-control plane devices 126 may not be considered to be candidate control nodes in the decentralized hierarchical control plane 102. A control node may manage the non-control plane devices 126 in a manner similar to that described above for devices in lower layers of the decentralized hierarchical control plane 102. For instance, the first device 104 may manage the non-control plane devices 126 as described herein. In some aspects, a device may exit the non-control plane 124 and enter the decentralized hierarchical control plane 102 or the device may exit the decentralized hierarchical control plane 102 and enter the non-control plane 124. In an example, the second device 106 may exit the decentralized hierarchical control plane 102 and enter the non-control plane 124, thus becoming part of the non-control plane devices 126. Entering and/or exiting the decentralized hierarchical control plane 102 and/or the non-control plane 124 may be based on a variety of factors, such as resource availability, network conditions, and/or system demands.

Although the description of FIG. 1 above describes a single device acting as a control node for each layer of the decentralized hierarchical control plane 102 (e.g., the first device 104 acts as the control node 122a in the first layer 118 and the sixth device 114 acts as the control node 122b in the zeroth layer 116), other possibilities are contemplated. In some aspects, a layer in the decentralized hierarchical control plane 102 may include more than one control node. Control nodes within a layer may collaborate with one another to manage device(s) in a lower layer in the decentralized hierarchical control plane 102.

Centralized control planes for system management (e.g., virtualization management including container management, virtual machine management, bare metal computing management) may struggle to manage the scale and diverse capabilities of edge devices, particularly when the edge devices are deployed alongside a hybrid cloud strategy. Aspects presented herein pertain to a decentralized control plane that is able to efficiently manage virtualization resources (and/or other resources) in scenarios involving a hybrid cloud.

In one aspect, a decentralized hierarchical control plane architecture (i.e., a decentralized hierarchical control plane) is described herein. The decentralized hierarchical control plane may efficiently manage virtualization resources (and/or other resources) across a wide range of edge devices and a hybrid cloud infrastructure. The decentralized hierarchical control plane may be configured to be adaptable and fault-tolerant and may provide resilient virtualization management in view of varying network conditions, device capabilities, and/or system demands.

In one aspect described herein, the decentralized hierarchical control plane may be configured to efficiently manage virtualization resources across edge devices and/or hybrid cloud environments. The decentralized hierarchical control plane may overcome limitations of centralized control planes by distributing management responsibilities across multiple control nodes, where the multiple control nodes may collaborate to make decisions and maintain overall system health. For instance, the multiple control nodes may participate in a consensus-like mechanism as part of the collaboration. The decentralized hierarchical control plane may be configured in view of a hierarchical structure. An architecture of the decentralized hierarchical control plane may include multiple layers of control nodes, where higher level nodes are responsible for coordinating lower level nodes. Such a hierarchy may enable a system to scale effectively and thus allow for an efficient management of a large number of edge devices and/or hybrid cloud resources. Such a hierarchy may utilize intelligent grouping from a capability perspective and/or a geolocation perspective in view of particular system demands. Control nodes may autonomously join or leave the decentralized hierarchical control plane and/or dynamically adjust the decentralized hierarchical control plane based on resource availability, network conditions, and/or system demands. Thus, the control nodes may handle failure cases (e.g., with edge devices) in which device(s) become nonoperational or otherwise impaired, such as when a device runs out of power. The decentralized hierarchical control plane may monitor data across various layers of the aforementioned hierarchy. In some aspects, a large quantity of data exists, and monitoring such data may be computationally intensive. To address this issue, a control node may employ various data filtering techniques and/or data distribution algorithms to reduce network utilization when monitoring the aforementioned data.

The decentralized hierarchical control plane may facilitate distributed decision making. For instance, in the decentralized hierarchical control plane, decisions regarding virtualization resource management may be collectively made be control nodes, rather than being dictated by a single central authority. The distributed decision making may enable the decentralized hierarchical control plane to leverage the collective intelligence of multiple nodes, which may lead to a more efficient and more resilient management of resources. The distributed decision making make facilitate scalability, load balancing, and resiliency in cases of system failures and/or resource constraints. In one aspect described herein, control nodes may utilize machine learning in order to analyze historical data, identify trends in the historical data, and/or preemptively predict issues.

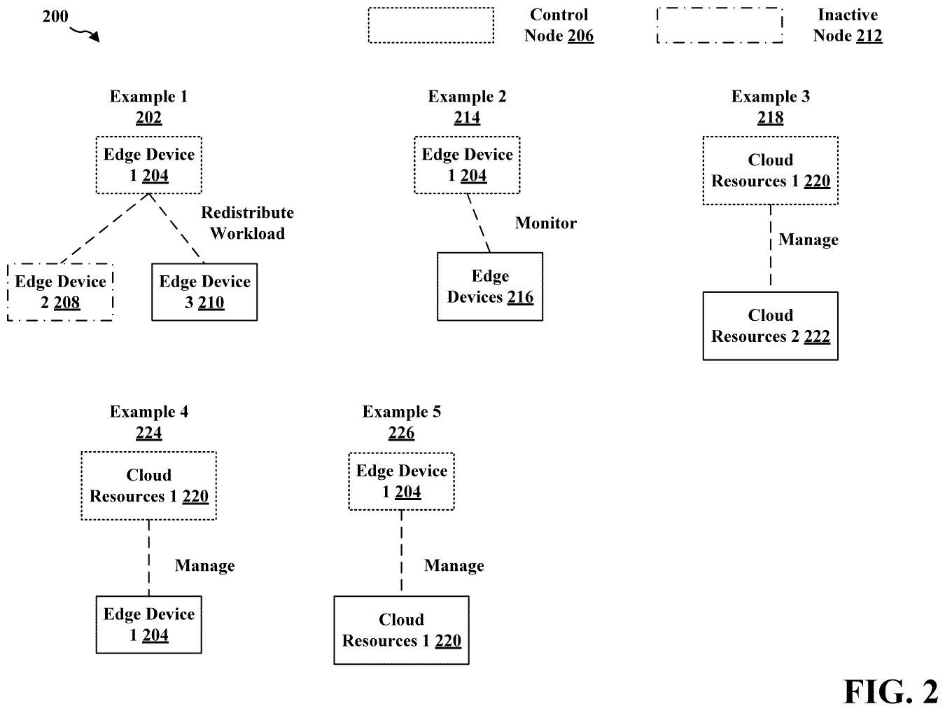

FIG. 2 is a block diagram 200 that illustrates examples of decentralized hierarchical control planes for management in edge devices and hybrid cloud environments in accordance with some aspects of the present disclosure. In a first example 202, a first edge device 204 may act as a control node 206 in a first layer of a decentralized hierarchical control plane (e.g., the decentralized hierarchical control plane 102). The first edge device 204 may manage a second edge device 208 and a third edge device 210 in a second layer of the decentralized hierarchical control plane. The second edge device 208 may be scheduled to or may be executing a workload. In the first example 202, the first edge device 204 acting as the control node 206 obtains an indication that the second edge device 208 has become or will become an inactive node 212, that is, the first edge device 204 obtains an indication that functionality of the second edge device 208 has become or will become impaired (e.g., nonoperational). The second edge device 208 may then be referred to as a “dead node.” The first edge device 204 may redistribute the workload from the second edge device 208 to the third edge device 210 based on the indication.

In a second example 214, the first edge device 204 may act as the control node 206 in a first layer of a decentralized hierarchical control plane (e.g., the decentralized hierarchical control plane 102). The first edge device 204 may manage edge devices 216 in a second layer of the decentralized hierarchical control plane. For instance, the first edge device 204 may monitor data associated with edge devices 216. The first edge device 204 may manage the edge devices 216 based on the monitored data.

In a third example 218, first cloud resources 220 may act as the control node 206 in a first layer of a decentralized hierarchical control plane (e.g., the decentralized hierarchical control plane 102), that is, device(s) in a first cloud associated with the first cloud resources 220 may act as the control node 206. The first cloud resources 220 may manage second cloud resources 222 in a second layer of the decentralized hierarchical control plane, that is, the first cloud resources 220 may manage device(s) in a cloud (e.g., the first cloud or a second cloud different from the first cloud) associated with the second cloud resources 222.

In a fourth example 224, the first cloud resources 220 may act as the control node 206 in a first layer of a decentralized hierarchical control plane (e.g., the decentralized hierarchical control plane 102), that is, device(s) in a first cloud associated with the first cloud resources 220 may act as the control node 206. The first cloud resources 220 may manage the first edge device 204 in a second layer of the decentralized hierarchical control plane.

In a fifth example 226, the first edge device 204 may act as the control node 206 in a first layer of a decentralized hierarchical control plane (e.g., the decentralized hierarchical control plane 102). The first edge device 204 may manage the first cloud resources 220 in a second layer of the decentralized hierarchical control plane, that is, the first edge device 204 may manage device(s) in a cloud) associated with the second cloud resources 222.

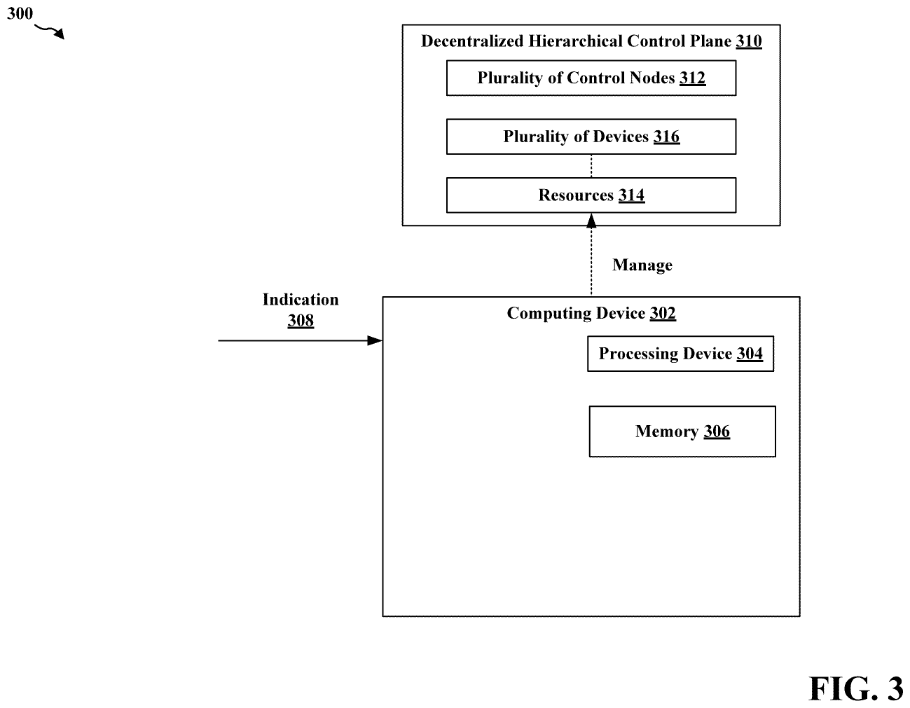

FIG. 3 is a block diagram 300 that illustrates an example of a system in accordance with some aspects of the present disclosure. The system includes a computing device 302. The computing device 302 includes a processing device 304 and a memory 306. The processing device 304 is operatively coupled to the memory 306.

The processing device 304 is to obtain, at a device (e.g., the computing device 302), an indication 308 that the device is to act as a control node in a decentralized hierarchical control plane 310, where the decentralized hierarchical control plane 310 includes a plurality of control nodes 312 in a decentralized hierarchy. The processing device 304 is to manage, at the device acting as the control node and via the decentralized hierarchical control plane 310, resources 314 associated with a plurality of devices 316 in the decentralized hierarchy.

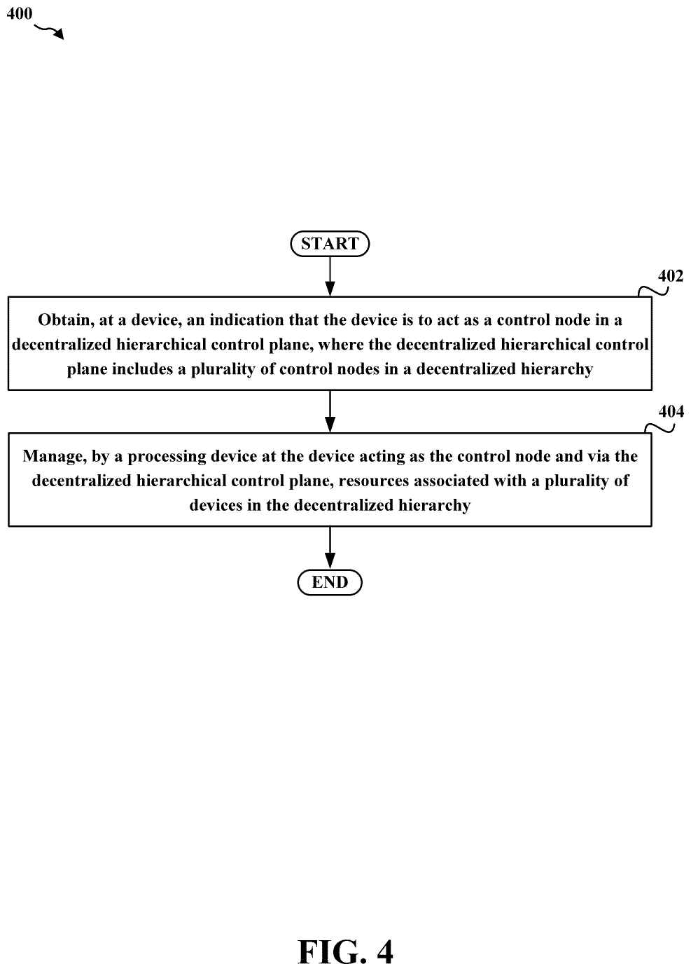

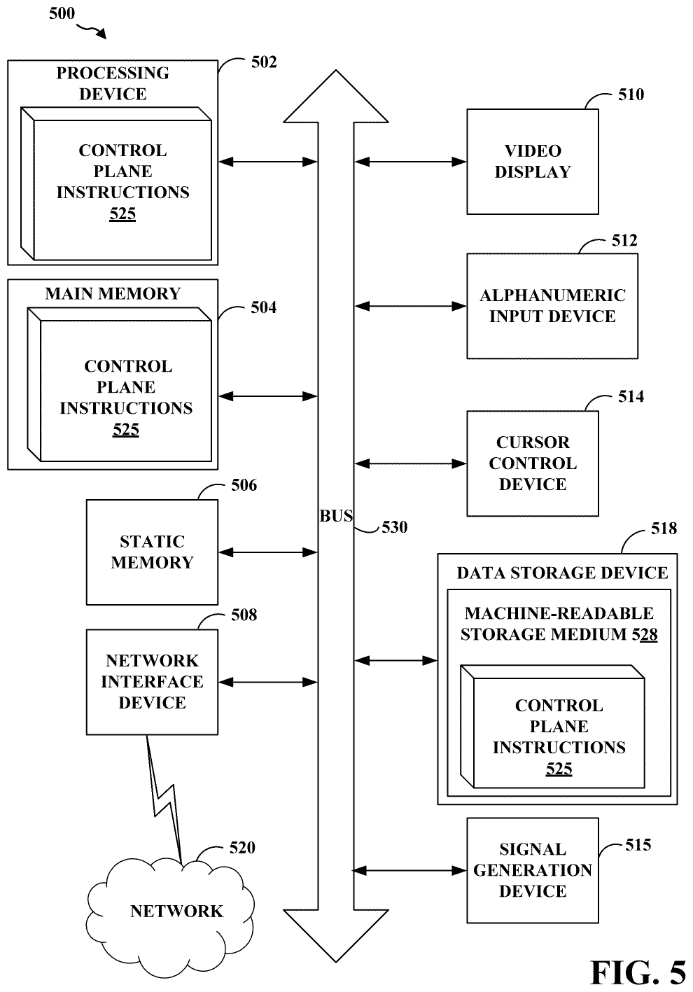

FIG. 4 is a flow diagram of a method 400 for a decentralized hierarchical control plane for management in edge devices and hybrid cloud environments in accordance with some aspects of the present disclosure. The method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some aspects, the method 400 may be performed by a computing device (e.g., computing device 302 in FIG. 3). For instance, the method 400 may be performed by the processing device 304. In some aspects, the method 400 may be performed by the machine depicted in FIG. 5. In some aspects, the method 400 may be performed by a device depicted in FIG. 1. In some aspects, the method 400 may be performed by an edge device or cloud resources depicted in FIG. 2.

At block 402, a processing device (of a device), obtains an indication that the device is to act as a control node in a decentralized hierarchical control plane, where the decentralized hierarchical control plane includes a plurality of control nodes in a decentralized hierarchy. In an example, the device may be the first device 104, the first edge device 204, the first cloud resources 220, or the computing device 302. In an example, the control node may be the control node 122a. In an example, the decentralized hierarchical control plane may be or include the decentralized hierarchical control plane 102 or the decentralized hierarchical control plane 310. In an example, the plurality of control nodes may include the first device 104 acting as the control node 122a and the sixth device 114 acting as the control node 122b. In another example, the plurality of control nodes may be the plurality of control nodes 312. In an example, the decentralized hierarchy may be or include the decentralized hierarchical control plane 102. In another example, the decentralized hierarchy may be or include the decentralized hierarchical control plane 102 and the non-control plane 124.

At block 404, the processing device, manages, at the device acting as the control node and via the decentralized hierarchical control plane, resources associated with a plurality of devices in the decentralized hierarchy. In an example, the plurality of devices may include the third device 108, the fourth device 110, and the fifth device 112. In another example, the plurality of devices may include the non-control plane devices 126. In a further example, the plurality of devices may include the plurality of devices 316. In yet another example, the plurality of devices may include the edge devices 216.

In some aspects, obtaining the indication that the device is to act as the control node may include obtaining an indication that a second device acting as a second control node within the decentralized hierarchical control plane has become nonoperational or impaired, and managing the resources may include managing the resources based on the indication that the second device acting as a second control node within the decentralized hierarchical control plane has become nonoperational or impaired. In an example, the aforementioned aspects may correspond to aspects described in the description of FIG. 1.

In some aspects, the decentralized hierarchy may be associated with at least one of a hybrid cloud environment or an edge computing environment. For example, the decentralized hierarchy described in the description of FIG. 1 may be associated with at least one of a hybrid cloud environment or an edge computing environment.

In some aspects, the processing device may determine, at the device, that the device is to cease acting as the control node. The processing device may transmit, by the device and based on the determination, an indication that a second device is to act as the control node. The processing device may cease managing the resources associated with the plurality of devices subsequent to transmitting the indication that the second device is to act as the control node. In an example, the second device may be the second device 106.

In some aspects, the processing device may detect, at the device, that functionality of the device will be impaired, where determining that the device is to cease acting as the control node may be based on the detection. For example, the first device 104 may detect that functionality of the device will be impaired, where determining that the device is to cease acting as the control node may be based on the detection.

In some aspects, the processing device may monitor data associated with at least one of the decentralized hierarchy or the decentralized hierarchical control plane, where managing the resources associated with the plurality of devices in the decentralized hierarchy may include managing the resources based on the data. In an example, the aforementioned aspects may correspond to the second example 214.

In some aspects, the processing device may execute, at the device, at least one of a data filtering technique or a data distribution technique on the data, where managing the resources associated with the plurality of devices in the decentralized hierarchy includes managing the resources based on executing the at least one of the data filtering technique or the data distribution technique on the data. In an example, the aforementioned aspects may correspond to aspects described in the description of FIG. 1.

In some aspects, the processing device may generate, at the device and via a machine learning model, a prediction pertaining to the resources associated with the plurality of devices based on the data, where managing the resources associated with the plurality of devices in the decentralized hierarchy may include managing the resources based on the prediction. In an example, the aforementioned aspects may correspond to aspects described in the description of FIG. 1.

In some aspects, managing the resources associated with the plurality of devices in the decentralized hierarchy may include transmitting, to the plurality of devices, a plurality of indications of adjustments to the resources, wherein the resources may be adjusted based on the plurality of indications. In an example, the aforementioned aspects may correspond to aspects described in the description of FIG. 1.

In some aspects, the resources may include at least one of: compute resources, network resources, virtualization associated resources, cloud resources, power resources, or a workload. In an example, the aforementioned aspects may correspond to aspects described in the description of FIG. 1.

In some aspects, the processing device may receive, at the device, an indication of a resource adjustment from a second device acting as a second control node in the decentralized hierarchical control plane, where the device may be associated with a first layer in the decentralized hierarchical control plane and the second device may be associated with a second layer in the decentralized hierarchical control plane, and where the second layer manages the first layer in the decentralized hierarchical control plane. The processing device may apply, at the device, the resource adjustment based on the indication of the resource adjustment. For example, the second device may be the sixth device 114 and the second control node may be the control node 122b. In an example, the first layer may be the first layer 118 and the second layer may be the zeroth layer 116.

In some aspects, the decentralized hierarchical control plane may include a plurality of layers, where each layer in the plurality of layers may be based on at least one of: a geographic region, a device type, a device capability, or a device use. For example, the plurality of layers may be or include the zeroth layer 116, the first layer 118, and the second layer 120.

In some aspects, the processing device may transmit, to at least a subset of the plurality of control nodes in the decentralized hierarchical control plane, a vote pertaining to the resources associated with the plurality of devices. The processing device may receive, at the device and from the at least the subset of the plurality of control nodes in the decentralized hierarchical control plane, votes pertaining to the resources associated with the plurality of devices, where managing the resources comprises managing the resources may be based on the vote and the votes. In an example, the aforementioned aspects may correspond to aspects described in the description of FIG. 1.

In some aspects, the device may act as the control node in a first layer of the decentralized hierarchical control plane. The processing device may obtain, at the device and from a second device in the decentralized hierarchical control plane, an indication that the device is to transition from the first layer of the decentralized hierarchical control plane to a second layer of the decentralized hierarchical control plane. The processing device may transition, at the device and based on the indication that the device is to transition, from the first layer of the decentralized hierarchical control plane to the second layer of the decentralized hierarchical control plane. In an example, the aforementioned aspects may correspond to aspects described in the description of FIG. 1.

In some aspects, the indication that the device is to transition may be based on at least one of resource availability, network conditions, or system demands. In an example, the aforementioned aspects may correspond to aspects described in the description of FIG. 1.

In some aspects, the plurality of devices may include a first device of a first type and a second device of a second type, where the first type may be different from the second type. For example, the first type may correspond to the first edge device 204 and the second type may correspond to the first cloud resources 220.

In some aspects, managing the resources associated with the plurality of devices in the decentralized hierarchy may include redistributing a workload from a first subset of the plurality of devices to a second subset of the plurality of devices. For example, the aforementioned aspects may correspond to the first example 202.

In some aspects, the device acting as the control node in the decentralized hierarchical control plane may host a workload. In an example, the aforementioned aspects may correspond to aspects described in the description of FIG. 1.

FIG. 5 illustrates a diagrammatic representation of a machine in the example form of a computer system 500 within which a set of instructions, for causing the machine to perform any one or more of the methodologies discussed herein for a decentralized hierarchical control plane for management in edge devices and hybrid cloud environments. More specifically, the machine may obtain, at a device, an indication that the device is to act as a control node in a decentralized hierarchical control plane, wherein the decentralized hierarchical control plane comprises a plurality of control nodes in a decentralized hierarchy; and manage, by a processing device at the device acting as the control node and via the decentralized hierarchical control plane, resources associated with a plurality of devices in the decentralized hierarchy

In alternative aspects, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or a bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one aspect, the computer system 500 may be representative of a server.

The computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., a speaker). In one example, the video display unit 510, the alphanumeric input device 512, and the cursor control device 514 may be combined into a single component or device (e.g., an LCD touch screen).

The processing device 502 represents one or more general-purpose processing devices such as a microprocessor, a central processing unit, or the like. More particularly, the processing device 502 may be a complex instruction set computing (CISC) microprocessor, a reduced instruction set computer (RISC) microprocessor, a very long instruction word (VLIW) microprocessor, or a processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), a network processor, or the like. The processing device 502 is configured with control plane instructions 525, for performing the operations and steps discussed herein. For example, the control plane instructions 525 may include instructions for obtaining, at a device, an indication that the device is to act as a control node in a decentralized hierarchical control plane, wherein the decentralized hierarchical control plane includes a plurality of control nodes in a decentralized hierarchy. The control plane instructions 525 may include instructions for managing, by a processing device at the device acting as the control node and via the decentralized hierarchical control plane, resources associated with a plurality of devices in the decentralized hierarchy.

The data storage device 518 may include a machine-readable storage medium 528 storing control plane instructions 525 (e.g., software) embodying any one or more of the methodologies of functions described herein. The control plane instructions 525 may also reside, completely or partially, within the main memory 504 or within the processing device 502 during execution thereof by the computer system 500; the main memory 504 and the processing device 502 also constituting machine-readable storage media. The control plane instructions 525 may further be transmitted or received over the network 520 via the network interface device 508.

The machine-readable storage medium 528 may also be used to store the control plane instructions 525 to perform a method for a decentralized hierarchical control plane for management in edge devices and hybrid cloud environments, as described herein. While the machine-readable storage medium 528 is shown in an exemplary aspect to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, a magnetic storage medium (e.g., floppy diskette), an optical storage medium (e.g., CD-ROM), a magneto-optical storage medium, a read-only memory (ROM), random-access memory (RAM), erasable programmable memory (e.g., EPROM and EEPROM), flash memory, or another type of medium suitable for storing electronic instructions.

The preceding description sets forth numerous specific details such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular aspects may vary from these exemplary details and still be contemplated to be within the scope of the present disclosure.

Additionally, some aspects may be practiced in distributed computing environments where the machine-readable medium is stored on and or executed by more than one computer system. In addition, the information transferred between computer systems may either be pulled or pushed across the communication medium connecting the computer systems.

Aspects of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another aspect, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” or “an implementation” or “one implementation” throughout is not intended to mean the same aspect or implementation unless described as such. Furthermore, the terms “first,” “second,” “third,” “fourth,” etc. as used herein are meant as labels to distinguish among different elements and may not necessarily have an ordinal meaning according to their numerical designation. Unless specifically stated otherwise, terms such as “obtaining,” “transmitting,” “receiving,” “managing,” “determining,” “ceasing,” “detecting,” “monitoring,” “executing,” “generating,” “applying,” “transitioning,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass aspects in hardware, software, or a combination thereof.

What is claimed is:

1. A method, comprising:
obtaining, at a device, an indication that the device is to act as a control node in a decentralized hierarchical control plane, wherein the decentralized hierarchical control plane comprises a plurality of control nodes in a decentralized hierarchy; and
managing, by a processing device at the device acting as the control node and via the decentralized hierarchical control plane, resources associated with a plurality of devices in the decentralized hierarchy.

2. The method of claim 1, further comprising:
determining, at the device, that the device is to cease acting as the control node;
transmitting, by the device and based on the determination, an indication that a second device is to act as the control node; and
ceasing, by the device, managing the resources associated with the plurality of devices subsequent to transmitting the indication that the second device is to act as the control node.

3. The method of claim 2, further comprising:
detecting, at the device, that functionality of the device will be impaired, wherein determining that the device is to cease acting as the control node is based on the detection.

4. The method of claim 1, further comprising:
monitoring data associated with at least one of the decentralized hierarchy or the decentralized hierarchical control plane, wherein managing the resources associated with the plurality of devices in the decentralized hierarchy comprises managing the resources based on the data.

5. The method of claim 4, further comprising:
executing, at the device, at least one of a data filtering technique or a data distribution technique on the data, wherein managing the resources associated with the plurality of devices in the decentralized hierarchy comprises managing the resources based on executing the at least one of the data filtering technique or the data distribution technique on the data.

6. The method of claim 4, further comprising:
generating, at the device and via a machine learning model, a prediction pertaining to the resources associated with the plurality of devices based on the data, wherein managing the resources associated with the plurality of devices in the decentralized hierarchy comprises managing the resources based on the prediction.

7. The method of claim 1, further comprising:
receiving, at the device, an indication of a resource adjustment from a second device acting as a second control node in the decentralized hierarchical control plane, wherein the device is associated with a first layer in the decentralized hierarchical control plane and the second device is associated with a second layer in the decentralized hierarchical control plane, and wherein the second layer manages the first layer in the decentralized hierarchical control plane; and
applying, at the device, the resource adjustment based on the indication of the resource adjustment.

8. The method of claim 1, further comprising:
transmitting, by the device and to at least a subset of the plurality of control nodes in the decentralized hierarchical control plane, a vote pertaining to the resources associated with the plurality of devices; and
receiving, at the device and from the at least the subset of the plurality of control nodes in the decentralized hierarchical control plane, votes pertaining to the resources associated with the plurality of devices, wherein managing the resources comprises managing the resources based on the vote and the votes.

9. The method of claim 1, wherein the device acts as the control node in a first layer of the decentralized hierarchical control plane, the method further comprising:
obtaining, at the device and from a second device in the decentralized hierarchical control plane, an indication that the device is to transition from the first layer of the decentralized hierarchical control plane to a second layer of the decentralized hierarchical control plane; and
transitioning, at the device and based on the indication that the device is to transition, from the first layer of the decentralized hierarchical control plane to the second layer of the decentralized hierarchical control plane.

10. The method of claim 9, wherein the indication that the device is to transition is based on at least one of resource availability, network conditions, or system demands.

11. The method of claim 1, wherein obtaining the indication that the device is to act as the control node comprises obtaining an indication that a second device acting as a second control node within the decentralized hierarchical control plane has become nonoperational or impaired, and wherein managing the resources comprises managing the resources based on the indication that the second device acting as the second control node within the decentralized hierarchical control plane has become nonoperational or impaired.

12. A system, comprising:
a memory; and
a processing device, operatively coupled to the memory, to:
obtain, at a device, an indication that the device is to act as a control node in a decentralized hierarchical control plane, wherein the decentralized hierarchical control plane comprises a plurality of control nodes in a decentralized hierarchy; and
manage, at the device acting as the control node and via the decentralized hierarchical control plane, resources associated with a plurality of devices in the decentralized hierarchy.

13. The system of claim 12, wherein the decentralized hierarchy is associated with at least one of a hybrid cloud environment or an edge computing environment.

14. The system of claim 12, wherein the resources comprise at least one of: compute resources, network resources, virtualization associated resources, cloud resources, power resources, or a workload.

15. The system of claim 12, wherein the decentralized hierarchical control plane comprises a plurality of layers, and wherein each layer in the plurality of layers is based on at least one of: a geographic region, a device type, a device capability, or a device use.

16. The system of claim 12, wherein the plurality of devices comprises a first device of a first type and a second device of a second type, and wherein the first type is different from the second type.

17. A non-transitory computer-readable medium having instructions stored thereon which, when executed by a processing device of a device, cause the processing device to:
obtain, at the device, an indication that the device is to act as a control node in a decentralized hierarchical control plane, wherein the decentralized hierarchical control plane comprises a plurality of control nodes in a decentralized hierarchy; and
manage, at the processing device of the device acting as the control node and via the decentralized hierarchical control plane, resources associated with a plurality of devices in the decentralized hierarchy.

18. The non-transitory computer-readable medium of claim 17, wherein to manage the resources associated with the plurality of devices in the decentralized hierarchy, the instructions, when executed by the processing device, cause the processing device to transmit, to the plurality of devices, a plurality of indications of adjustments to the resources, wherein the resources are adjusted based on the plurality of indications.

19. The non-transitory computer-readable medium of claim 17, wherein to manage the resources associated with the plurality of devices in the decentralized hierarchy, the instructions, when executed by the processing device, cause the processing device to redistribute a workload from a first subset of the plurality of devices to a second subset of the plurality of devices.

20. The non-transitory computer-readable medium of claim 17, wherein the device acting as the control node in the decentralized hierarchical control plane hosts a workload.
